(19) United States
(12) Patent Application Publication
(10) Pub. No.: US 2006/0066751 A1
(43) Pub. Date: Mar. 30, 2006

(54) Micro-photoing system

(76) Inventor: Yen Hao Lu, Taichung City (TW)

Correspondence Address: PRO-TECHTOR INTERNATIONAL, 20775 Norada Court, Saratoga, CA, 95070-3018, US

(21) Appl. No.: 10/950,220

(22) Filed: Sep. 24, 2004

(51) Int. Cl. H04N 5/222

(52) U.S. Cl. 348/370

(57) ABSTRACT

A micro-photoing system includes a base with a supporting member connected thereon. An analysis unit is connected on the supporting member and includes a CCD camera disposed to one side of the analysis unit and having a micro-lens, a lens fixing base, a CCD focus adjusting base, a CCD angle adjusting member, a CCD x-y micro-adjusting base connected beneath the CCD angle adjusting member, and a fixing base on which the CCD x-y micro adjusting base is connected. A light source is located at the other side of the analysis unit and a fist fixing member, a second fixing member and a third fixing member are respectively connected to the light source.

### FIELD OF THE INVENTION

The present invention relates to a micro-photoing system for checking the positions of crystals of wafers, LCDs or LEDs.

### BACKGROUND OF THE INVENTION

A conventional testing system for observing the connection points of crystals of glass structure has some inherent shortcomings which are:
1. The conventional testing system cannot observe the connection points of crystals of wafers, LEDs, LCDs, or wafers. This shortage usually results to a unsatisfied cutting.
2. The conventional testing system cannot move smoothly and precisely.
3. The conventional testing system cannot provide the images of the crystals or the glass structure when using the conventional testing system.
4. The rate of production cannot be increased and the final products include a high rate of defection.

The present invention intends to provide a micro-photoing system for checking the positions of crystals of wafers, LCDs or LEDs.

### SUMMARY OF THE INVENTION

The present invention relates to a micro-photoing system that comprises a base with a supporting member connected thereon. An analysis unit is connected on the supporting member and includes a CCD camera disposed to one side of the analysis unit and having a micro-lens, a lens fixing base, a CCD focus adjusting base, a C CD angle adjusting member, a CCD x-y micro-adjusting base connected beneath the CCD angle adjusting member, and a fixing base on which the CCD x-y micro-adjusting base is connected. A light source is located at the other side of the analysis unit and a fist fixing member, a second fixing member and a third fixing member are respectively connected to the light source.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the micro-photoing system of the present invention;

FIG. 2 is a perspective view to show the micro-photoing system of the present invention, and

FIG. 3 is a perspective view to show the micro-photoing system without the base of the present invention.

### DETAILED DESCRIPTION OF THE PREFERRED EMBODIMENT

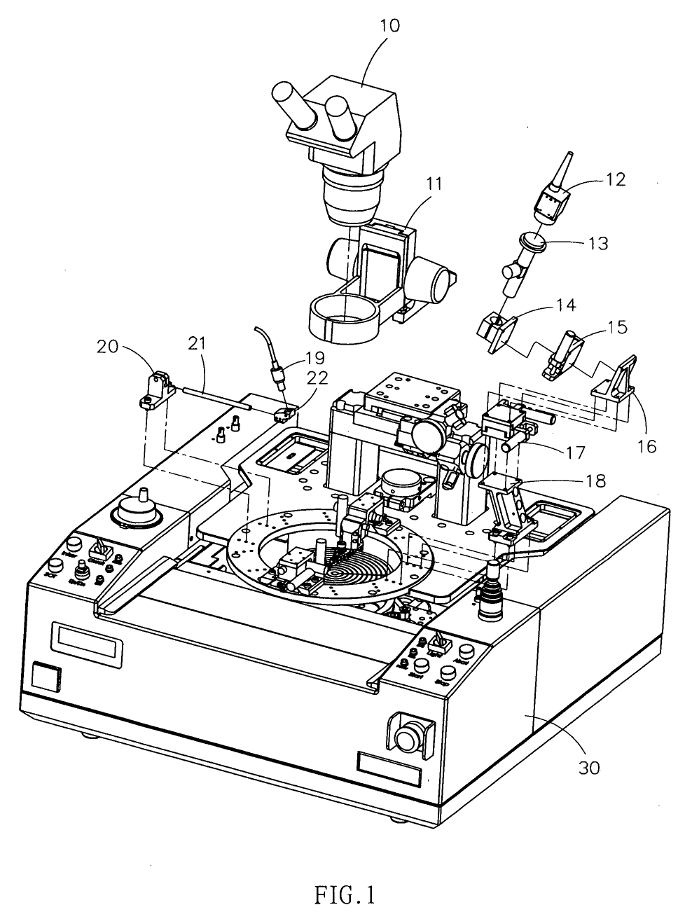

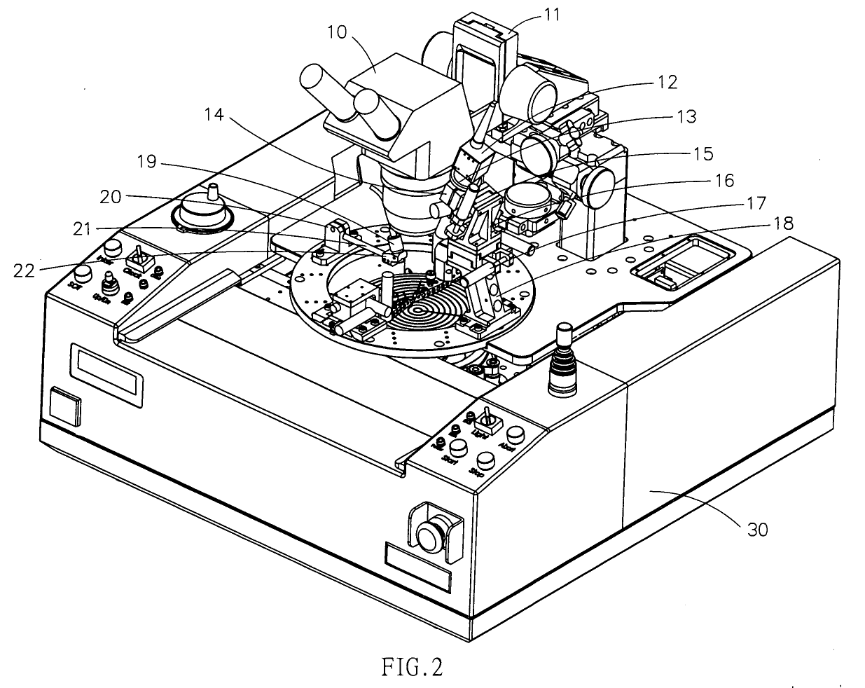

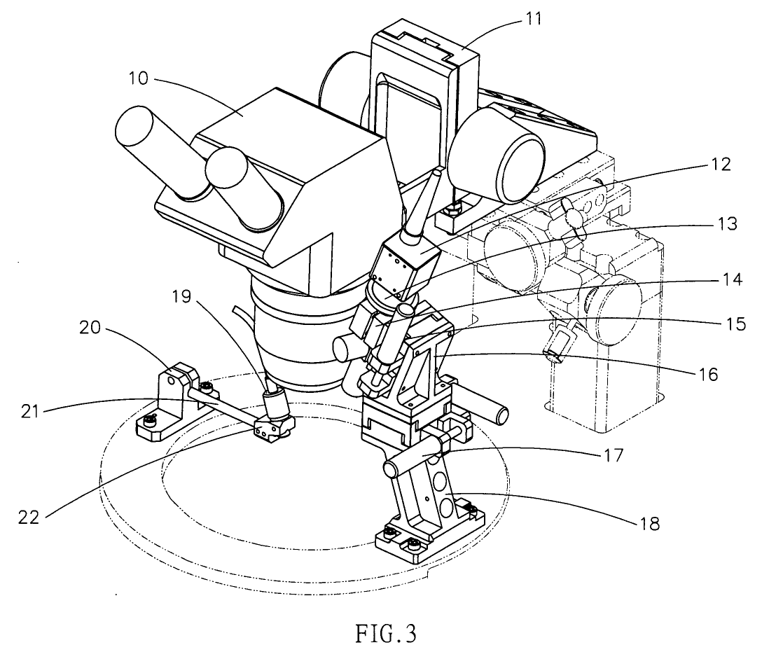

Referring to FIGS. 1 to 3, the micro-photoing system of the present invention comprises a base 30 and a supporting member 11 is connected on the base 30. An analysis unit 10 is connected on the supporting member 11, a CCD camera 12 disposed to one side of the analysis unit 10 and having a micro-lens 13, a lens fixing base 14, a CCD focus adjusting base 15, a CCD angle adjusting member 16, a CCD x-y micro-adjusting base 17 connected beneath the CCD angle adjusting member 16, and a fixing base 18 on which the CCD x-y micro-adjusting base 17 is connected

A light source 19 is located at the other side of the analysis unit 10 and a fist fixing member 20, a second fixing member 21 and a third fixing member 22 respectively connected to the light source 19.

When using the system the CCD camera 12 provides a visual image of the crystals and the positions by the coordinate of X and Y axes. By this way, the user can obtain a more precise data of the test and improves the shortcomings of the conventional test systems.

While we have shown and described the embodiment in accordance with the present invention, it should be clear to those skilled in the art that further embodiments may be made without departing from the scope of the present invention.

What is claimed is:

1. A micro-photoing system comprising:
a base and a supporting member connected on the base, an analysis unit connected on the supporting member, a CCD camera disposed to one side of the analysis unit and having a micro-lens, a lens fixing base, a CCD focus adjusting base, a CCD angle adjusting member, a CCD x-y micro-adjusting base connected beneath the CCD angle adjusting member, and a fixing base on which the CCD x-y micro-adjusting base is connected, and
a light source located at the other side of the analysis unit and a fist fixing member, a second fixing member and a third fixing member respectively connected to the light source.
